(19) United States
(12) Patent Application Publication
(10) Pub. No.: US 2003/0038247 A1
(43) Pub. Date: Feb. 27, 2003

(54) Watertight electrodeless irradiation apparatus and method for irradiating packaging materials

(76) Inventors: Todd Schweitzer, Torrance, CA (US); Douglas S. DeLong, Torrance, CA (US)

Correspondence Address: Charles H. Thomas, CISLO & THOMAS LLP, Suite 405, 4201 Long Beach Blvd., Long Beach, CA, 90807-2022, US

(21) Appl. No.: 09/939,543

(22) Filed: Aug. 27, 2001

(51) Int. Cl. G21K 5/00

(52) U.S. Cl. 250/455.11

(57) ABSTRACT

A NEMA 4 watertight irradiation apparatus is provided for irradiating food and pharmaceutical packaging. The irradiation apparatus employs a microwave excited ultraviolet radiation generator that includes an electrodeless lamp that produces ultraviolet radiation. The UV radiation generator is enclosed within a watertight housing having a floor in which an irradiation window opening is defined. A quartz window is mounted in a frame at the window opening at the bottom of the housing. The quartz window allows UV radiation from the microwave powered UV lamp of the ultraviolet radiation generator to pass from the lamp to the target area, which is typically a moving conveyor belt located beneath the housing. Inlet and outlet air ducts in the removable lid of the housing circulate ambient air to cool both the magnetron and the lamp of the UV radiation generator. The irradiation apparatus of the invention meets NEMA 4 standards for a watertight apparatus. The method of the invention increases throughput by decreasing downtime when interruptions to the conveyor system occur.

### BACKGROUND OF THE INVENTION

1. Field of the Invention

The present invention relates to a NEMA 4, watertight electrodeless irradiation apparatus and a method for irradiating food and pharmaceutical packaging products.

2. Description of the Prior Art

At present food packaging products such as dairy product cartons, lids, sealing films, plastic wrap, labels, and other articles used in the packaging of food products are sanitized by irradiation. In conventional food packaging sanitizing operations the packaging is passed on a conveyor beneath a conventional lamp that emits ultraviolet radiation and which is driven by a magnetic ballast. The National Electrical Manufacturers Association (NEMA) has established a numeric rating system for different types of commercial and industrial enclosures. The numbers of this rating system indicate the extent to which an enclosure is airtight, dustproof, or watertight.

In the food packaging processing industry the packaging irradiation stations are such that the packaging treatment equipment must be capable of being washed down with water and other liquid cleansers. Consequently, irradiation equipment used to treat articles of food packaging must be housed within an enclosure having a watertight rating, which is a NEMA 4 rating. In conventional food packaging irradiation systems, therefore, the magnetic ballast driving the ultraviolet lamp is located remotely and is coupled by a cable to an enclosure for the UV lamp that has a NEMA 4 rating.

The use of an ultraviolet lamp driven by a magnetic ballast has several distinct disadvantages. One primary disadvantage is that a warmup period of between about five and ten minutes is required each time the magnetic ballast is turned on and a cooling off period of the same duration is required each time the magnetic ballast is turned off. In irradiating food packaging it is frequently necessary to turn the system on and off. This becomes necessary when the conveyor system temporarily runs out of caps or other packaging or when paper jams occur. Each time this happens there is a lengthy delay in shutting down in the magnetic ballast driven ultraviolet lamp and then starting it up again.

One attempt to solve this problem involves the use of shutters that block the ultraviolet light. When the shutdown of a conveyor line is necessary, the ultraviolet radiation source is not turned off, but mechanical shutters are operated to prevent the ultraviolet light from shining on the conveyor line. This allows attendants to clear the line. However, these mechanical shutter systems do sometimes fail. Such a failure is extremely serious, since paper packaging on the line can catch fire and wax covered cartons can melt. Consequently, the use of shutters to block ultraviolet light is far from satisfactory.

One approach to ultraviolet radiation in the sanitization of food packaging products which has not heretofore been attempted is irradiation utilizing an ultraviolet radiation generating system that employs an electrodeless lamp. Instead of being driven by a magnetic ballast an electrodeless lamp is driven by a magnetron. Ultraviolet radiation systems of this type have for many years been employed in drying paint. More recently, it has been suggested that such a system could be utilized for oxidation of toxins in water. U.S. Pat. No. 6,090,296 suggests such an application. However, the irradiation system employed in this patent is not watertight and would be unable to meet the NEMA 4 standard required of food packaging irradiation processing.

### SUMMARY OF THE INVENTION

A primary object of the present in invention is to provide a novel system of food packaging irradiation that solves the problem of excessive time for warming up and cooling down ultraviolet radiation lamps that has existed for many years in the food packaging sanitization industry. This object is achieved by employing an ultraviolet radiation generator that includes an electrodeless lamp. Such a lamp, driven by a magnetron, typically takes only about 11 seconds to warm up or cool down. Therefore, the downtime on a conveyor irradiation treatment line for sanitizing food packaging is greatly reduced. The system can also be utilized to treat packaging materials for pharmaceutical products.

A further object of the invention is to provide an ultraviolet radiation generator that includes an electrodeless lamp with a housing that meets the watertight requirement standard of NEMA 4. This is accomplished by providing an ultraviolet radiation generator including an electrodeless lamp with a stainless steel housing that encapsulates all of the operating components of the ultraviolet radiation generator in a watertight manner.

In one broad aspect the present invention may be considered to be an irradiation apparatus comprising: a NEMA 4 watertight housing that forms an enclosure and which has a floor in which an irradiation window opening is defined. A quartz window is disposed across the window opening in watertight, sealed engagement therewith. A microwave excited ultraviolet radiation generator that includes an electrodeless lamp that produces ultraviolet radiation is positioned within the watertight housing proximate the window opening. The ultraviolet radiation generator emits ultraviolet radiation through the quartz window to an area at the exterior of the housing beneath the quartz window. An air inlet duct is provided to the housing for directing cooling air toward the electrodeless lamp. An air outlet duct is provided from the housing for withdrawing from the housing air that has passed the electrodeless lamp.

Preferably the system is provided with a baffle that is located within the watertight housing. The baffle is positioned in the path of the air inlet duct. The purpose of the baffle is to aid in reflecting air from the air inlet duct toward the electrodeless lamp and on to the outlet duct. The baffle preferably has perforations defined through its structure. The outer housing and the inner baffle are both preferably formed of stainless steel.

Considered in another aspect the invention may be considered to be an apparatus for irradiating packaging materials to neutralize harmful bacteria. The apparatus of the invention is comprised of a NEMA 4 waterproof housing that forms an enclosure and which has a floor in which an irradiation window opening is defined. A quartz window is disposed across the window opening in watertight sealed engagement therewith. A microwave excited ultraviolet radiation generator is provided that includes an electrodeless lamp that produces ultraviolet radiation. This lamp is positioned within the watertight housing and proximate the window opening. The lamp emits the ultraviolet radiation through the quartz window to packaging materials located outside the housing beneath the quartz window. An air inlet duct to the housing is provided for directing cooling air toward the electrodeless lamp. An air outlet duct from the housing is provided for withdrawing air from the housing that has passed the electrodeless lamp.

In still another aspect the invention may be considered to be a method of irradiating articles of packaging to neutralize harmful bacteria utilizing an irradiation apparatus. The irradiation apparatus employed includes a NEMA 4 watertight housing that forms an enclosure. The housing has a floor in which an irradiation window opening is defined. A quartz window is disposed across the window opening in watertight sealed engagement therewith. A microwave excited ultraviolet radiation generator that includes an electrodeless lamp is positioned within the watertight housing proximate the window opening. The electrodeless ultraviolet lamp emits ultraviolet radiation through the quartz window to an irradiation treatment area at the exterior of the housing beneath the quartz window. An air inlet duct is provided to the housing and an air outlet duct is provided from the housing.

The steps of the invention involve conveying food, pharmaceutical, or other packaging through the irradiation treatment area, and concurrently providing power to the electrodeless lamp to irradiate the articles of packaging to neutralize harmful bacteria thereon.

The invention may be described with greater clarity and particularity by reference to the accompanying drawings.

### DESCRIPTION OF THE DRAWINGS

FIG. 1 is a front elevational view of a preferred embodiment of a watertight irradiation apparatus according to the invention.

FIG. 2 is a front sectional elevational view of the watertight irradiation apparatus shown in FIG. 1.

FIG. 3 is a bottom plan view of the watertight irradiation apparatus shown in FIG. 1 taken along the lines 3-3 of FIG. 1.

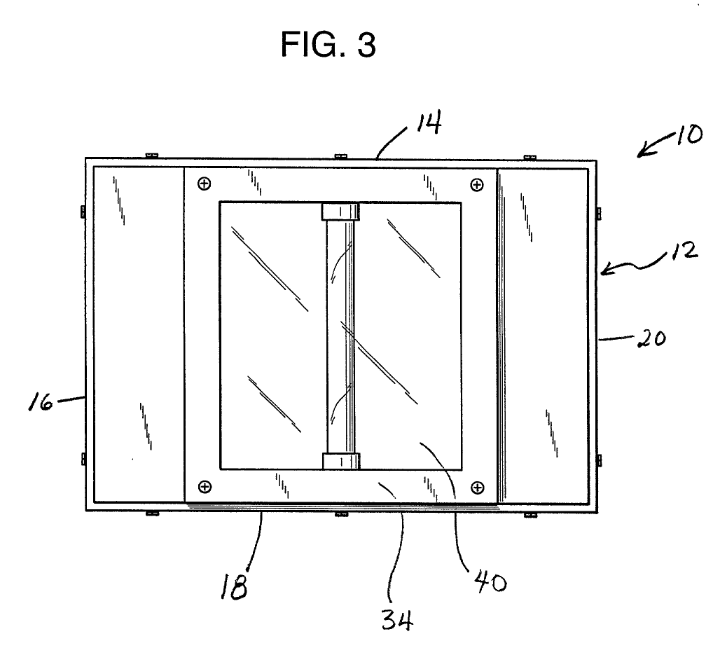

FIG. 4 is a left-side elevational view of the embodiment of the irradiation apparatus taken along the lines 4-4 of FIG. 1.

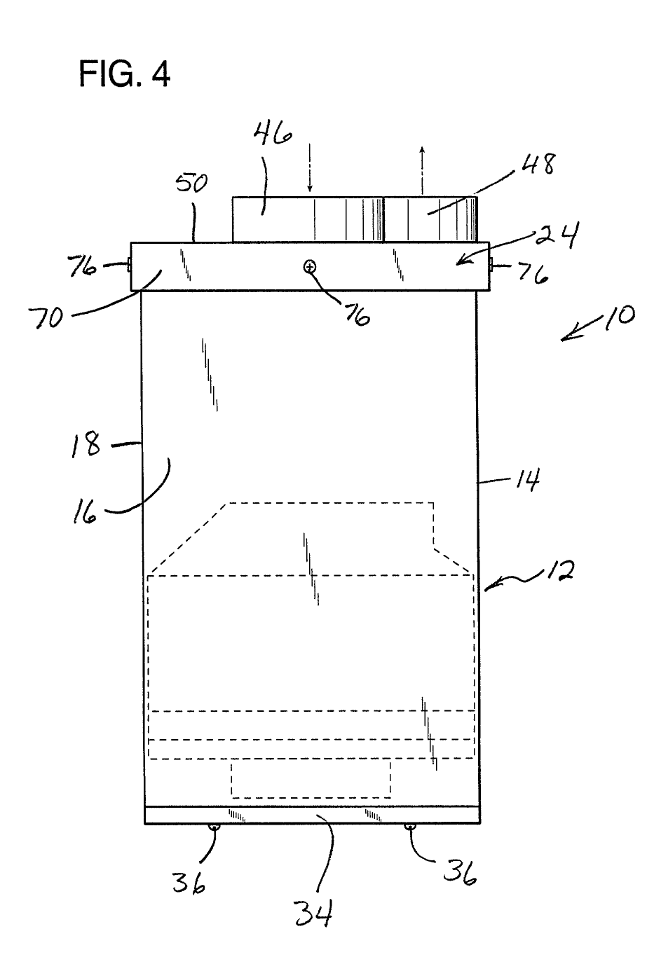

FIG. 5 is a top plan view of the embodiment of the irradiation apparatus shown in FIG. 1.

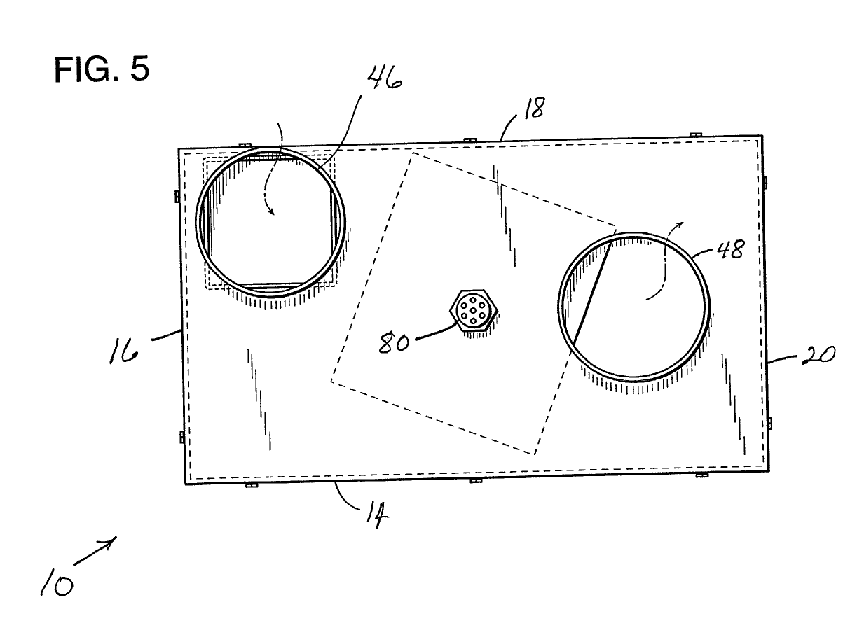

### DESCRIPTION OF THE EMBODIMENT

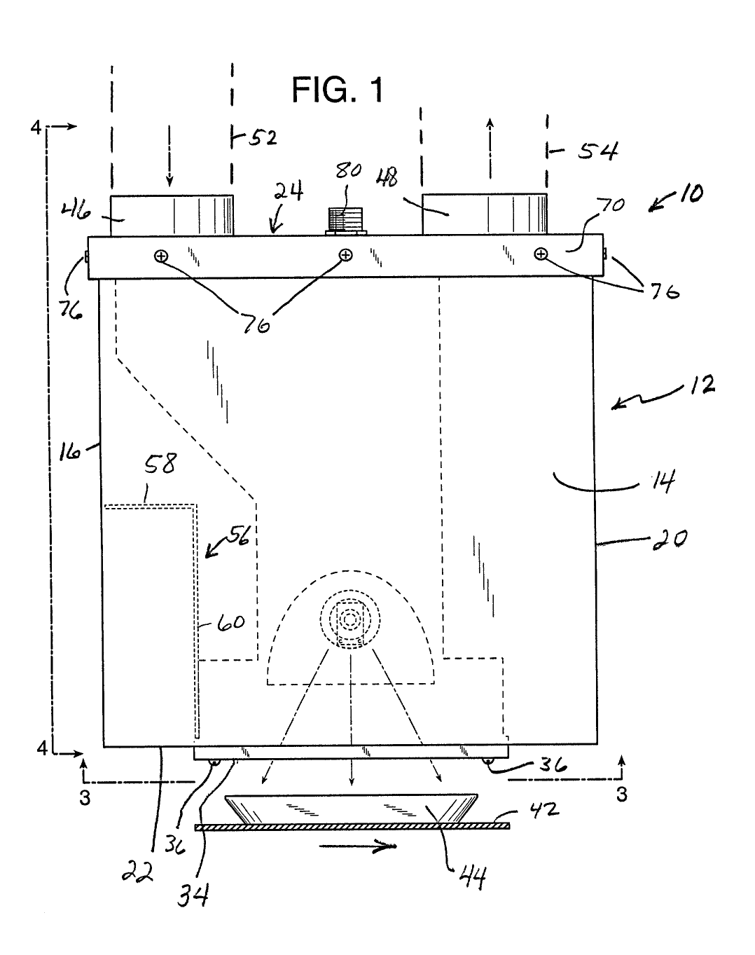

FIG. 1 illustrates an ultraviolet irradiation apparatus indicated generally at 10. The irradiation apparatus 10 is comprised of a box-like NEMA 4 watertight stainless steel housing 12 that includes upright, generally vertical walls 14, 16, 18, and 20, a stainless steel floor 22 and a removable lid 24. The exterior of the watertight housing 12 is shaped generally in the form of a rectangular prism.

The housing 12 forms an enclosure for a microwave excited ultraviolet radiation generator 26 that includes an electrodeless lamp 28 that produces ultraviolet radiation. Preferably, the operating components of the ultraviolet radiation generator 26 are those of the F300 Series ultraviolet generator manufactured by Fusion UV Systems, Inc., located at 910 Clopper Road, Gaithersburg, Md. 20878-1357. Units of this type are sold with a standard, aluminum housing. However, the aluminum housing is removed and only the operating components of the F300 microwave powered ultraviolet radiation generator are included within the housing 12 of the system of the invention in order to improve air circulation and cooling.

An inverted perforated, parabolic reflector 30 is located above the magnetron actuated ultraviolet lamp 28 to aid in focusing ultraviolet radiation emitted by the lamp 28 through a rectangular window opening 32 defined in the floor 22 of the housing 12. The stainless steel housing has an overall height of about twelve inches, a width of about thirteen inches, and a depth of about seven inches. The depth is the dimension of the housing 12 that lies parallel to the longitudinal alignment of the tubular lamp 28. The window opening 32 has a width of 6-½ inches and a depth of 5.313 inches.

A rectangular, stainless steel window opening frame 34 is positioned beneath the window opening 32 and secured thereto by bolts 36. A gasket 38 is interposed between the frame 34 and the floor 22 of the housing 12 to ensure a watertight seal. A rectangular sheet of quartz is mounted in the window frame 34 and serves as a quartz window 40. The downwardly facing peripheral edges of the quartz window 40 are secured by cement to the window frame 34.

The quartz window 40 allows ultraviolet light to pass from the lamp 28 to the target area at the exterior of the housing 12 beneath the quartz window 40. This target area is the upper surface of a conveyor belt 42 located directly beneath the floor 22 of the housing 12. The quartz window 40 also acts as a barrier to keep water and dust away from the lamp 28. If required, the quartz window 40 can also act as a filter to keep infrared energy generated from the lamp 28 from getting to the target area. This is especially important for applications in which the packaging material to be treated is heat sensitive.

The lamp 28 is six inches in length and is positioned within the watertight housing 12 proximate to the window opening 32 to emit ultraviolet radiation through the quartz window 40. In the operation of the apparatus 10, the ultraviolet radiation is directed onto articles of food or pharmaceutical packaging, indicated at 44, to disinfect the packaging 44 with ultraviolet radiation. The articles of food packaging 44 are carried past the quartz window 40 by the conveyor belt 42.

The watertight housing 12 is also provided with an air inlet duct 46 for directing cooling air toward the electrodeless lamp 28 and an air outlet duct 48 for withdrawing air from the housing 12 that has passed the electrodeless lamp 28. The air inlet duct 46 and the air outlet duct 48 are both three inches in diameter and one inch long. The ducts 46 and 48 are both welded all around circular openings in the flat roof 50 of the lid 24. The ducts 46 and 48 are respectively connected in fluid-tight engagement with conduits 52 and 54, indicated in phantom, that lead to ambient air, typically through the roof of a building in which the irradiation process is carried out.

Within the enclosure of the watertight housing 12 there is a baffle 56 that is positioned in the path of the air inlet duct 46. The baffle 56 aids in deflecting air from the air inlet duct 46 toward the electrodeless lamp 28 and on to the outlet duct 48. The baffle 56 has an inverted L-shaped cross section that includes a horizontal portion 58 that extends inwardly from the inner surface of the upright wall 16 a distance of 2.375 inches. A vertical section 60 of the baffle 56 extends downwardly from the inner edge of the horizontal section 58 a distance of 4.75 inches. The baffle 56 is perforated with a multiplicity of apertures indicated at 62.

The ultraviolet radiation generator 26 has a pair of laterally separated support rails 64 and 66 that are supported by several spacer blocks 68. The spacer blocks 68 have a one inch square cross section and elevate the support rails 64 and 66 of the ultraviolet radiation generator 26 above the housing floor 22 a distance of 0.87 inches. Thus, there are elongated open slots several inches long and 0.87 inches in height beneath the rails 64 and 66 and between the spacer blocks 68 through which cooling air can pass.

The upright stainless steel walls 14, 16, 18, and 20 of the housing 12 extend upwardly from the floor 22 to laterally enclose the ultraviolet radiation generator 26 there within. The roof 50 of the lid 24 is flat and extends slightly beyond the upper ends of the upright walls 14, 16, 18, and 20. The lid 24 includes a peripheral lip 70 at the edges of the roof 50 that projects downwardly a distance of one inch alongside the upper ends of the walls 14, 16, 18, and 20. There is preferably a gap of about 0.177 inches between the lip 70 and the walls 14, 16, 18, and 20 encompassed there within. There is a compressible soft rubber or foam pad 74 that is located on the underside of the roof 50 of the lid 24. The gasket pad 74 is 0.12 inches in thickness in an uncompressed state.

Openings are defined through the peripheral lip 70 and the upper ends of the housing walls 14, 16, 18, and 20 at eight locations about the circumference of the housing 12 so that the lid 24 must be pressed down slightly to compress the gasket pad 74 in order to engage screws 76 in the corresponding fastener openings in the lid 70 and fastener openings in the upright walls 14, 16, 18, and 20. The compression of the gasket pad 74 ensures a watertight seal between the lid 24 and the walls 14, 16, 18, and 20. Nevertheless, the lid 24 is removable for servicing the ultraviolet radiation generator 26.

Electrical power is supplied to the ultraviolet radiation generator 26 through an electrical socket connection 80 formed in the roof 50 of the lid 24. A compressible rubber grommet may be used to form a watertight seal between the socket 80 and the roof 50.

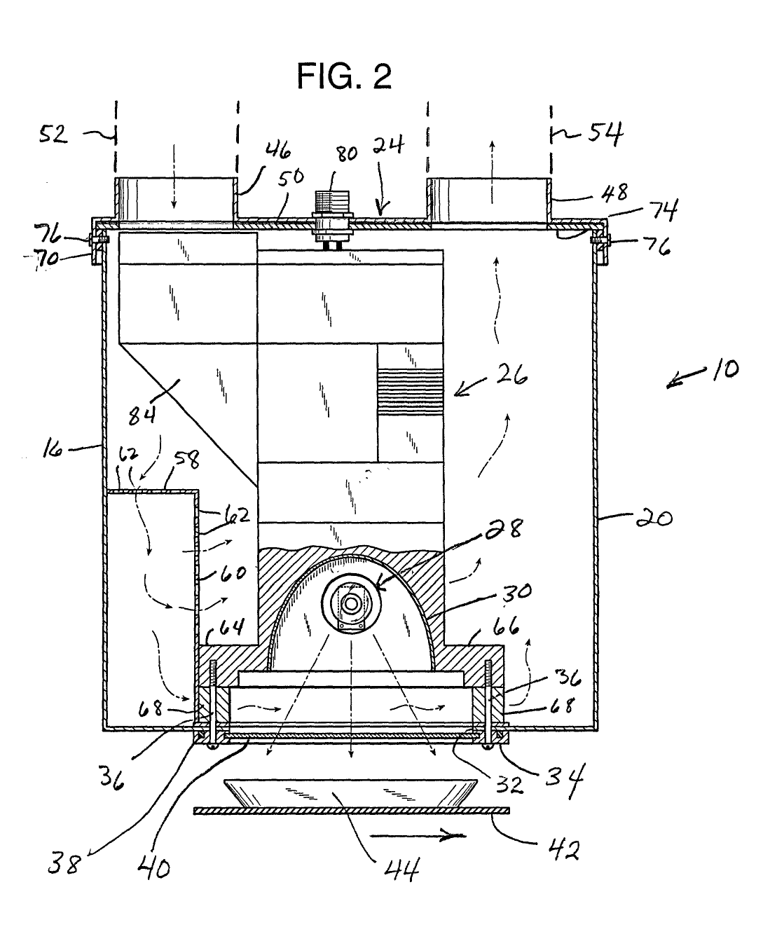

In the operation of the irradiation apparatus 10, the conveyor 42, which may be a conveyor belt, carries a series of food packaging or pharmaceutical packaging articles 44 past the quartz window 40, from left to right as viewed in FIG. 2. The magnetron of the ultraviolet radiation generator 26 receives electrical power through an electrical connector coupled to the socket 80 so that the electrodeless bulb 28 generates ultraviolet radiation. At the same time an external blower (not shown) forces ambient cooling air downwardly through the conduit 52 into the housing 12 and through the air inlet duct 46.

An air funnel 84 is formed within the structure of the housing 12 and is located a short distance below the air inlet duct 46 and in the flow path of air arriving from the inlet duct 46. Therefore, a major portion of the cooling air enters the air funnel 84 and is deflected downwardly to the right to cool the ultraviolet radiation generator magnetron and then passes downwardly through the perforations in the reflector 30 to cool the ultraviolet radiation bulb 28. This cooling air, heated by the magnetron and the ultraviolet bulb 28, then passes laterally to the right through the slot that exists between the spacing blocks 68 and beneath the rail 66. The exhaust air is then forced upwardly within the housing 12 and out of the irradiation apparatus 10 through the outlet duct 48.

Because there is no airtight connection between the air inlet duct 46 and the air funnel 84, a certain portion of the air bypasses the air funnel 84 and is directed downwardly to the baffle 56 that lies in its path. The baffle 56 tends to deflect the downwardly flowing cooling air to the right, as viewed in FIGS. 1 and 2, toward the magnetron and the ultraviolet generating bulb 28. In this way most of the cooling air from the air inlet duct 46 is directed toward the magnetron and ultraviolet bulb 28 to cool those components.

A small portion of the air does pass through the perforations 62 in the baffle 56 to maintain a positive pressure beneath the baffle 56 to aid in conveying cooling air laterally to the right across the floor 22 of the housing 12 and beyond the ultraviolet radiation generator 26. Once the air passes beyond the ultraviolet radiation generator 26, the circulation flow within the housing 12 forces it upwardly as exhaust air that is vented to the atmosphere through the outlet duct 48.

The irradiation apparatus 10 according to the invention serves as an ideal device for irradiating food packaging and pharmaceutical packaging to neutralize harmful bacteria and sanitize the packaging that it treats. The packaging 44 is carried from left to right through the irradiation treatment area directly beneath the window opening 32, as viewed in FIG. 1, while power is provided to the electrodeless bulb 28. The food packaging 44 is irradiated by the ultraviolet radiation generated by the bulb 28 and passing through the quartz window 40. The ultraviolet radiation generated irradiates the food or pharmaceutical packaging 44 to neutralize harmful bacteria that may exist on it. At the same time cooling air is directed toward the electrodeless bulb 28, while air that has passed the electrodeless bulb 28 is withdrawn from the housing.

The system has a nearly instantaneous off and on capability. That is, should problems develop in the conveyor belt 42, power to the bulb 28 can be turned off nearly instantly. The problem can then be cleared and power to the bulb 28 resumed just as quickly.

A further advantage of using the electrodeless lamp 28 is that it lasts much longer than a lamp operated from a magnetic ballast. The biggest advantage of the system, however, is that it meets the NEMA 4 standard required for sanitizing food and pharmaceutical packaging. That is, the housing 12 will remain leak proof, withstanding water delivered from a one inch hose at 65 gallons per minute from a 10 ft. distance for five minutes or more.

Undoubtedly, numerous variations and modifications of the invention will become readily apparent to those familiar with sanitizing food packaging and pharmaceutical packaging. Accordingly, the scope of the invention should not be construed as limited to the specific embodiment depicted and described, but rather is defined in the claims appended hereto.

I claim

1. An irradiation apparatus comprising:
a NEMA 4 watertight housing that forms an enclosure and which has a floor in which an irradiation window opening is defined,
a quartz window disposed across said window opening in watertight sealed engagement therewith,
a microwave excited ultraviolet radiation generator that includes an electrodeless lamp that produces ultraviolet radiation positioned within said watertight housing proximate said window opening to emit said ultraviolet radiation through said quartz window to an area at the exterior of said housing beneath said quartz window,
an air inlet duct to said housing for directing cooling air toward said electrodeless lamp, and
an air outlet duct from said housing for withdrawing from said housing air that has passed said electrodeless lamp.

2. An irradiation apparatus according to claim 1 further comprising a baffle located within said watertight housing and positioned in the path of said air inlet duct to aid in deflecting air from said air inlet duct toward said electrodeless lamp and on to said air outlet duct.

3. An irradiation apparatus according to claim 3 further characterized in that said baffle has perforations defined therethrough.

4. An irradiation apparatus according to claim 1 wherein said floor of said watertight housing is formed of stainless steel and said watertight housing is further comprised of laterally enclosing upright stainless steel walls extending up from said floor and a stainless steel lid to which said air inlet and air outlet ducts are joined.

5. Apparatus for irradiating packaging materials to neutralize harmful bacteria comprising:
a NEMA 4 waterproof housing that forms an enclosure and which has a floor in which an irradiation window opening is defined,
a quartz window disposed across said window opening in watertight, sealed engagement therewith,
a microwave excited ultraviolet radiation generator that includes an electrodeless lamp that produces ultraviolet radiation positioned within said watertight housing proximate said window opening to emit said ultraviolet radiation through said quartz window to packaging materials located outside said housing beneath said quartz window,
an air inlet duct to said housing for directing cooling air toward said electrodeless lamp, and
an air outlet duct from said housing for withdrawing from said housing air that has passed said electrodeless lamp.

6. An apparatus according to claim 5 further comprising a deflecting baffle located within said watertight housing aligned with the path of air flow through said air inlet duct, whereby said baffle aids in deflecting air from said air inlet duct toward said electrodeless lamp.

7. An apparatus according to claim 6 wherein said baffle has perforations defined therethrough.

8. An apparatus according to claim 5 in which said floor of said watertight housing is formed of stainless steel and said housing is further comprised of upright stainless steel walls surrounding said ultraviolet radiation generator and a removable stainless steel lid located atop said upright walls, and said air inlet and said air outlet ducts are joined to said stainless steel lid in perpendicular orientation relative to said floor, and said housing is further comprised of a compressible, watertight gasket interposed between said removable lid and said upright walls to maintain a watertight seal therebetween.

9. A method of irradiating articles of packaging to neutralize harmful bacteria utilizing irradiation apparatus that includes:
a NEMA 4 watertight housing that forms an enclosure and which has a floor in which an irradiation window opening is defined,
a quartz window disposed across said window opening in watertight sealed engagement therewith,
a microwave excited ultraviolet radiation generator that includes an electrodeless lamp that produces ultraviolet radiation positioned within said watertight housing proximate said window opening to emit said ultraviolet radiation through said quartz window to an irradiation treatment area at the exterior of said housing beneath said quartz window,
an air inlet duct to said housing, and
an air outlet duct from said housing, the steps comprising:
conveying food packaging through said irradiation treatment area, and
concurrently providing power to said electrodeless lamp to irradiate said food packaging to neutralize harmful bacteria thereon.

10. A method according to claim 9 further comprising directing cooling air toward said electrodeless lamp.

11. A method according to claim 10 further comprising withdrawing from said housing air that has passed said electrodeless lamp.
